(19) United States
(12) Patent Application Publication
(10) Pub. No.: US 2024/0328346 A1
(43) Pub. Date: Oct. 3, 2024

(54) ENGINE

(71) Applicant: ISUZU MOTORS LIMITED, Yokohama-shi (JP)

(72) Inventor: Shinichi MORITA, Fujisawa-shi (JP)

(21) Appl. No.: 18/609,549

(22) Filed: Mar. 19, 2024

(30) Foreign Application Priority Data
Mar. 28, 2023 (JP) 2023-052041

(51) Int. Cl. F02B 65/00; F01L 13/00

(52) U.S. Cl. CPC F02B 65/00; F01L 13/00

(57) ABSTRACT

Provided is an engine including: a cylinder; a piston that reciprocates inside the cylinder; an intake valve through which intake air is supplied into the cylinder; an exhaust valve through which air inside the cylinder is expelled; and a compressed air taking-out valve through which air compressed inside the cylinder is taken out. The compressed air taking-out valve is open during a compression stroke in which the piston compresses the air inside the cylinder.

### CROSS REFERENCE TO RELATED APPLICATIONS

This application is entitled to the benefit of Japanese Patent Application No. 2023-052041, filed on Mar. 28, 2023, the disclosure of which including the specification, drawings and abstract is incorporated herein by reference in its entirety.

### TECHNICAL FIELD

The present disclosure relates to an engine.

### BACKGROUND ART

Conventionally, a vehicle, for example, a bus or a truck, uses air (compressed air) for an air brake, an air suspension, opening/closing of a door, and the like, and an air compressor for supplying air is mounted in the vehicle. A lot of air compressors are driven by the power of the engine, and when the air compressor operates, a load is applied to the engine and the fuel is consumed.

In the case of a diesel engine at a low load, the diesel engine is in a state of being supplied with excess air. An engine that takes out oxygen to a bypass passage in the case of a low load to thereby reduce oxygen to be supplied has been taken into consideration (for example, see Patent Literature (hereinafter referred to as “PTL”) 1).

### CITATION LIST

### Patent Literature

### PTL 1

Japanese Utility Model (Registration) Application No. H04-28898 (Japanese Utility Model (Registration) Application Laid-Open No. H05-87259) (CD-ROM)

### SUMMARY OF INVENTION

### Technical Problem

The high-pressure air used in a vehicle is generated by an electric air compressor driven by the power of the engine. Accordingly, when the air compressor operates, the load on the engine increases and fuel consumption increases. It is effective to shorten the operation time of the air compressor.

An object of the present disclosure is to reduce fuel consumption and improve the fuel economy of an engine by shortening the operation time of an air compressor.

### Solution to Problem

In order to achieve the above-mentioned object, an engine in an embodiment of the present disclosure includes: a cylinder; a piston that reciprocates inside the cylinder; an intake valve through which intake air is supplied into the cylinder; an exhaust valve through which air inside the cylinder is expelled; and a compressed air taking-out valve through which air compressed inside the cylinder is taken out. The compressed air taking-out valve is open during a compression stroke in which the piston compresses the air inside the cylinder.

### Advantageous Effects of Invention

Since compressed air is utilized after being taken out from a cylinder assembly that forms an engine, it is possible to shorten the operation time of an air compressor.

### BRIEF DESCRIPTION OF DRAWINGS

FIG. 1 illustrates a configuration of a cylinder assembly;

FIG. 2 illustrates a relationship among a crank angle, an exhaust valve opening period, an intake valve opening period, and a compressed air taking-out valve opening period in motoring; and

FIG. 3 illustrates a relationship among the crank angle, the exhaust valve opening period, the intake valve opening period, and the compressed air taking-out valve opening period at a low load.

### DESCRIPTION OF EMBODIMENTS

Hereinafter, an embodiment of the present disclosure will be described with reference to the accompanying drawings.

### <Configuration of Cylinder Assembly>

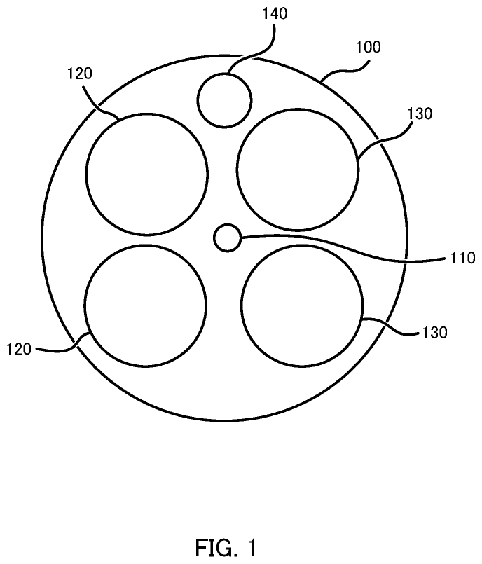

FIG. 1 illustrates a configuration of cylinder assembly 100 that forms an engine. It is assumed that the engine is a so-called diesel engine that uses diesel as the fuel. Cylinder assembly 100 is formed of a cylinder and a piston that reciprocates inside the cylinder. FIG. 1 illustrates an outline of cylinder assembly 100 in which the ceiling surface of the cylinder, which is provided with fuel injector 110, intake valves 120, exhaust valves 130, and the like, is viewed from the piston.

Cylinder assembly 100 includes fuel injector 110, intake valve 120, exhaust valve 130, and compressed air taking-out valve 140.

Each of fuel injector 110, intake valve 120, and exhaust valve 130 has a well-known configuration, and thus, descriptions thereof will be omitted.

Compressed air taking-out valve 140 is a valve through which high-pressure air in the cylinder assembly is taken out. Compressed air taking-out valve 140 is open during the compression stroke of the engine and air compressed into the cylinder assembly is taken out therethrough. Compressed air taking-out valve 140 may be smaller than intake valve 120 and exhaust valve 130.

### <Timing of Opening/Closing of Valve>

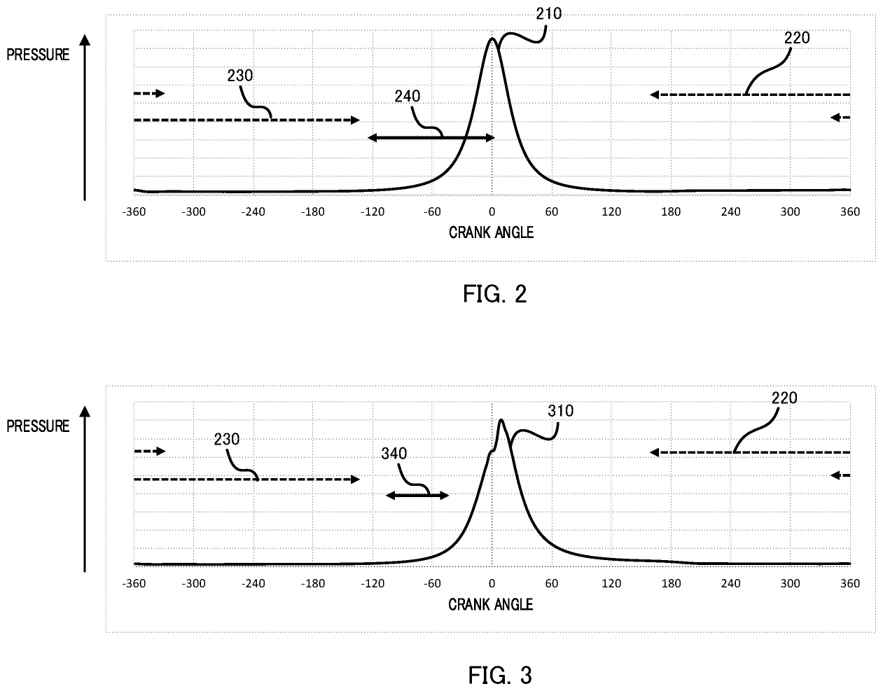

FIG. 2 illustrates a relationship among a crank angle, an exhaust valve opening period, an intake valve opening period, and a compressed air taking-out valve opening period at the time of motoring of the engine.

The reference sign 210 indicates a change in pressure in the cylinder assembly with respect to the crank angle. In the motoring, the fuel is not injected and there is no fuel combustion, either, and thus, the pressure in the cylinder assembly decreases when the crank angle exceeds 0 degrees.

The reference sign 220 indicates the exhaust valve opening period (a period in which the exhaust valve is open and air is expelled therethrough).

The reference sign 230 indicates the intake valve opening period (a period in which the intake valve is open and air is taken in therethrough).

The reference sign 240 indicates the compressed air taking-out valve opening period (a period in which the compressed air taking-out valve is open and compressed air is taken out therethrough). Since the fuel is not injected in the motoring, compressed air taking-out valve 140 opens and compressed air is taken out therethrough when the exhaust valve and the intake valve are closed and the compression stroke starts. Compressed air taking-out valve opening period 240 starts after intake valve opening period 230 ends. Since air has been taken out in the compression stroke, when the crank angle increases after the crank angle exceeds 0 degrees (expansion stroke), atmospheric pressure in the cylinder assembly decreases, and thus, it is possible to obtain an effect of increased engine braking.

FIG. 3 illustrates a relationship among the crank angle, the exhaust valve opening period, the intake valve opening period, and the compressed air taking-out valve opening period at the time of low-load operation of the engine.

The reference sign 310 indicates a change in pressure in the cylinder assembly with respect to the crank angle. At a low load, the fuel is injected, the fuel explodes, and the pressure rises, and thus, the pressure in the cylinder assembly in a position in which the crank angle exceeds 0 degrees is high.

The reference sign 220 indicates the exhaust valve opening period.

The reference sign 230 indicates the intake valve opening period.

The reference sign 340 indicates the compressed air taking-out valve opening period. Since the fuel needs to be burned at a low load, it is necessary to suppress taking-out of compressed air to an extent of taking-out thereof in which the fuel is burned normally. Accordingly, compressed air taking-out valve opening period 340 is shorter than compressed air taking-out valve opening period 240 in the motoring. Compressed air taking-out valve opening period 340 starts after intake valve opening period 230 ends. Compressed air taking-out valve opening period 340 ends before the fuel is injected from fuel injector 110 (angle 0). Since the pressure in the cylinder assembly decreases by the opening of compressed air taking-out valve 140, it is desirable not to open compressed air taking-out valve 140 immediately prior to the injection of the fuel. The amount of work in the compression stroke decreases due to a decrease in the pressure in the cylinder assembly by taking out compressed air, and thus, the fuel economy of the engine itself can be improved.

The length of compressed air taking-out valve opening period 340 may vary depending on the load (fuel injection amount), and compressed air taking-out valve opening period 340 is shorter when the load is heavier. A first period in which compressed air taking-out valve 140 is open in a case where a required load on the engine is higher than a threshold is shorter than a second period in which compressed air taking-out valve 140 is open in a case where the required load on the engine is lower than the threshold. In a case where the load on the engine is higher than another threshold, compressed air taking-out valve opening period 340 may be 0. The load on the engine may be detected by an engine load sensor. As the engine load sensor, it is possible to use, for example, a sensor that detects the accelerator opening degree.

The compressed air taken out from the cylinder assembly after compressed air taking-out valve 140 opens is stored in an air tank in which air compressed by an air compressor is stored, and is used for an air brake or the like.

The amount of compressed air generated by the air compressor can be reduced for the amount of compressed air taken out from the cylinder assembly, and thus, the operation time of the air compressor can be shortened for the reduced amount of compressed air. Further, it is possible to use a small air compressor.

Note that, although the present embodiment has been described using, as the configuration of the engine, a configuration in which the fuel is injected by the fuel injector, the present disclosure is not limited thereto. For a gasoline-driven engine, a CNG engine, and the like, the injection by the fuel injector may be read as ignition by a spark plug.

### Variation

Compressed air may be taken out only at the time of motoring of the engine and may not be taken out at the time of a low-load operation of the engine.

An air tank is provided with a safety valve for preventing pressure from becoming too high. Accordingly, even in a case where the pressure in the air tank becomes too high due to compressed air taken out through compressed air taking-out valve 140, the safety of the air tank is not affected thereby. In order that the pressure in the air tank does not become too high, the opening/closing of compressed air taking-out valve 140 may be controlled according to the pressure in the air tank.

(1) An engine in an embodiment of the present disclosure includes: a cylinder; a piston that reciprocates inside the cylinder; an intake valve through which intake air is supplied into the cylinder; an exhaust valve through which air inside the cylinder is expelled; and a compressed air taking-out valve through which air compressed inside the cylinder is taken out. The compressed air taking-out valve is open during a compression stroke in which the piston compresses the air inside the cylinder.

(2) In the engine in (1) in the embodiment of the present disclosure, the compressed air taking-out valve is open in a case where the intake valve and the exhaust valve are closed.

(3) The engine in (1) in the embodiment of the present disclosure further includes a fuel injector that injects fuel into the cylinder. The compressed air taking-out valve is open in a case where the fuel is not injected from the fuel injector.

(4) The engine in (1) in the embodiment of the present disclosure further includes a fuel injector that injects fuel into the cylinder. The compressed air taking-out valve is open in a period after the intake valve is closed and before the fuel is injected from the fuel injector.

(5) In the engine in (1) in the embodiment of the present disclosure, the period in which the compressed air taking-out valve is open is a period according to a required load on the engine.

(6) In the engine in (1) in the embodiment of the present disclosure, a first period in which the compressed air taking-out valve is open in a case where the required load on the engine is higher than a threshold is shorter than a second period in which the compressed air taking-out valve is open in a case where the required load on the engine is lower than the threshold.

(7) A vehicle in the embodiment of the present disclosure includes the engine in (1).

### INDUSTRIAL APPLICABILITY

The present disclosure is useful for an engine.

1. An engine, comprising:
a cylinder;
a piston that reciprocates inside the cylinder;
an intake valve through which intake air is supplied into the cylinder;
an exhaust valve through which air inside the cylinder is expelled; and
a compressed air taking-out valve through which air compressed inside the cylinder is taken out, wherein
the compressed air taking-out valve is open during a compression stroke in which the piston compresses the air inside the cylinder.

2. The engine according to claim 1, wherein
the compressed air taking-out valve is open in a case where the intake valve and the exhaust valve are closed.

3. The engine according to claim 1, further comprising a fuel injector that injects fuel into the cylinder, wherein
the compressed air taking-out valve is open in a case where the fuel is not injected from the fuel injector.

4. The engine according to claim 1, further comprising a fuel injector that injects fuel into the cylinder, wherein
the compressed air taking-out valve is open in a period after the intake valve is closed and before the fuel is injected from the fuel injector.

5. The engine according to claim 1, wherein
the period in which the compressed air taking-out valve is open is a period according to a required load on the engine.

6. The engine according to claim 5, wherein
a first period in which the compressed air taking-out valve is open in a case where the required load on the engine is higher than a threshold is shorter than a second period in which the compressed air taking-out valve is open in a case where the required load on the engine is lower than the threshold.

7. A vehicle, comprising the engine according to claim 1.
